(19) United States
(12) Patent Application Publication
(10) Pub. No.: US 2006/0073434 A1
(43) Pub. Date: Apr. 6, 2006

(54) Silicone elastomerics for orthodontia

(76) Inventor: James M. Reynolds, Lubbock, TX (US)

Correspondence Address: MICHAEL A. O'NEIL, P.C., 5949 SHERRY LANE, SUITE 820, DALLAS, TX, 75225, US

(21) Appl. No.: 10/958,909

(22) Filed: Oct. 4, 2004

(51) Int. Cl. A61C 3/00

(52) U.S. Cl. 433/18; 433/20; 433/15

(57) ABSTRACT

An elastomeric adapted to apply constant pressure between orthodontic appliances is formed from silicone. The elastomeric comprises various shapes and configurations. The elastomeric is preferably formed from TUFEL® II 94706, LIM® 6040, or equivalent materials.

### TECHNICAL FIELD

This invention relates generally to orthodontics, and more particularly to the use of silicone elastomerics in the practice of orthodontia.

### BACKGROUND AND SUMMARY OF THE INVENTION

For over fifty years the orthodontics profession has sought improved techniques for moving teeth to correct sagittal relations or occusal disharmonies. Head gears, heavy continuous forces applied by rubber bands, coil springs, magnets, etc. have been tried and are still relied on in cases requiring massive movements of groups or segments of the dentitions.

Latex rubber bands have been by far the most common source of gentle forces used to move one sector of dentition as it relates to another sector. Changing the relationships of teeth preferably employs a constant force. Rubber bands show a rapid deterioration of force in the human mouth. As is said by dentists, “The human mouth is a strange laboratory.” Within hours, latex elastics lose much of their strength and become useless. Frequent changing is required. Patient cooperation to overcome this need is a real problem.

Eurathane modules, shaped as small rings, are currently the product of choice for holding metal archwires in place on attachments, such as brackets. Orthodontic brackets, bonded to the enamel surface of various teeth, act as handles for applying forces to individual teeth. Eurathane has been shown by numerous tests to have a short effective life in orthodontic applications. According to numerous studies eurathane absorbs saliva in the oral cavity, rapidly swelling and losing over 40% of its original strength or elasticity in a period of forty eight hours. By the time a patient returns to the orthodontic practitioner for replacements, usually every four weeks, the eurathane is as limp and useless as pasta.

Chains of small eurathane modules are used to close spaces occurring between various teeth. These too, lose over half their effectiveness in three or four days. Discoloration is an esthetic problem as well.

The present invention comprises improvements in the art and science of orthodontia which overcome the foregoing and other problems which have long since characterized the prior art. In accordance with the broader aspects of the invention, elastomerics intended for use in the practice of orthodontia are formed from silicone. Under the conditions prevalent in the oral cavity silicone compounds do not discolor, do not take on moisture, and retain most of their strength and elasticity over a period exceeding six weeks. Patient cooperation is no longer a problem, as no change is required in the application of the desired continuous forces needed to achieve the movement of selected dental units. Additionally elastomerics comprising the present invention hold archwires in place in slots provided in brackets attached to the dental units. Continuous forces, as preferred, are thereby applied in the desired directions, either moving teeth via brackets along the metal archwires or alternatively holding the archwire firmly in the slot of the bracket which is attached to the individual tooth.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view illustrating a first embodiment of the invention;

FIG. 2 is an illustration of the use of the present invention in the practice of orthodontia;

FIG. 3 is a top view illustrating a second embodiment of the invention;

FIG. 4 is a perspective view illustrating a third embodiment of the invention;

FIG. 5 is a perspective view illustrating a fourth embodiment of the invention; and

FIG. 6 is an illustration of a fifth embodiment of the invention.

### DETAILED DESCRIPTION

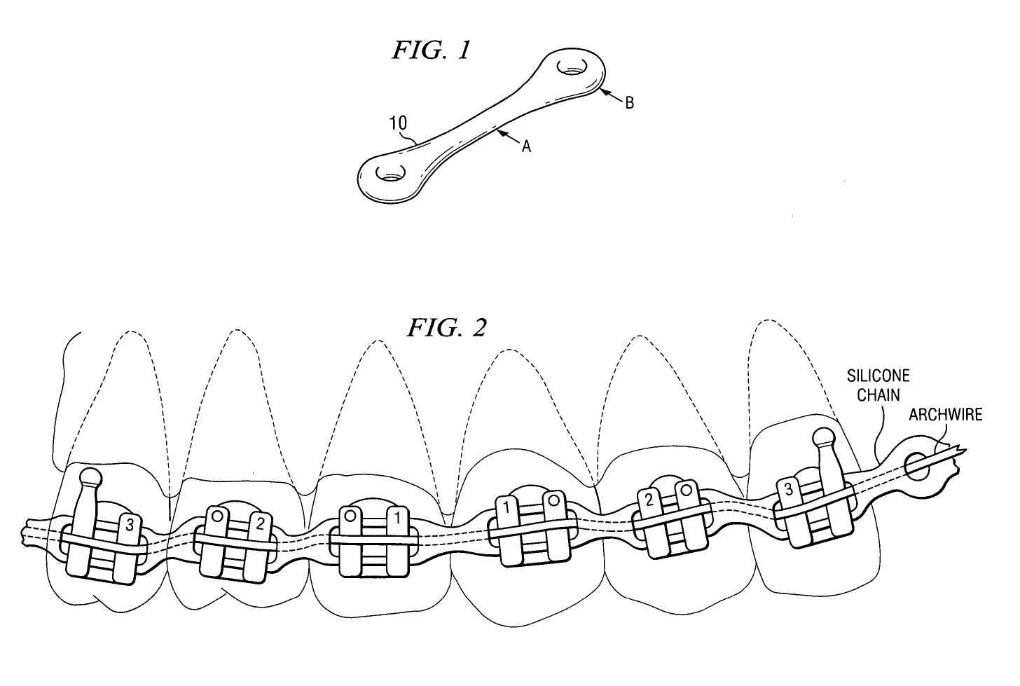

Referring now to the Drawings and particularly to FIG. 1 thereof, there is shown a power bar 10 comprising a first embodiment of the invention. In accordance with the invention, the power bar 10 is injection molded from silicone compounds. For example, the power bar 10 may be formed from a silicone material selected from the group consisting of TUFEL® II 94706 and LIM® 6040. The power bar 10 may also be formed from two or more compounds of silicone. The compounds are in liquid forms, at controlled temperatures. As the liquids meet in the designed configuration of the mold, the resulting composition creates a solid structure identical to the design of the mold.

In accordance with the invention the cross sectional thickness of the power bar 10 at location A is the same as the cross sectional thickness of the power bar 10 at location B. In this manner the force applied by the power bar 10 is evenly distributed along the entire length thereof.

The durometer or elasticity of the power bar 10 can be increased or decreased by varying the composition thereof. Color additives may be included in the material utilized in the manufacturer of the power bar 10 thereby distinguishing power bars having various durometers or elasticities by color variations.

Pictured in FIG. 2 is a very useful embodiment of the invention, a continuous chain. Edgewise brackets, the most commonly used attachment that is bonded to the facial surface of the teeth provide an upper and lower wing or wings. Under this wing a steel ligature or a bracket encircling module is placed to hold the archwire in place. By replacing the module or ligature with modules forming a chain, a space closing action results. Since the urethane chains commonly used for this purpose lose their strength, usually in forty eight to seventy two hours, the injection molded silicone chain comprising the present invention is vastly superior. The silicone chain, shown in tests to exhibit a strong hysteresis, does not require replacement every few days to be effective. Doctor appointments requiring chain replacements can be spaced at four to eight week intervals, as little or no swelling or loss of strength occurs when silicone compounds are placed in the mouth.

When stretched from tooth to tooth, a continuous closing action is provided. The same action can be used to move single teeth along the archwire that rests in the slots of the brackets attached to the involved teeth.

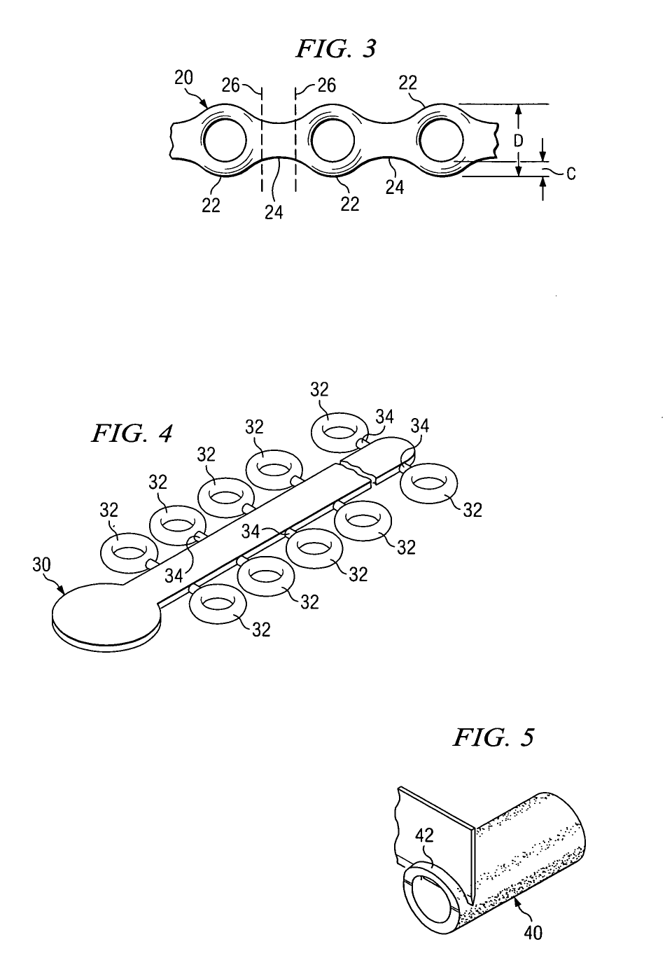

Referring to FIG. 3 the present invention may also take the form of a chain 20 comprised in a plurality of rings 22 which are interconnected by rods 24. Prior to utilization, the rings 22 are separated from the rods 24 by cutting along lines 26.

Utilization of the rings 22 of the chain 20 in orthodontia is substantially identical to the utilization of the power bar 10 as illustrated in FIG. 2 and described hereinabove in conjunction therewith. As will be indicated by those skilled in the art, the rings 22 can also be used to ligate orthodontic brackets to orthodontic archwires. The cross sectional dimension C of the rings 22 is typically between about 0.60 millimeters and about 1.20 millimeters. The dimension D is typically about 3 millimeters.

The durometer or elasticity of the rings 22 may be varied by changing the composition thereof. The rings 22 may be manufactured in a variety of colors to indicate variations in the cross sectional thickness and the durometer thereof. The rings 22 are preferably manufactured from a silicone material selected from the group consisting of TUFEL® II 94706 and LIM® 6040.

Referring to FIG. 4, there is shown a stick 30 comprising a third embodiment of the invention. The stick 30 has a plurality of rings 32 secured to the opposite sides thereof by a plurality of rods 34. Prior to utilization the rings 32 are separated from the rods 34 by cutting or breaking away, under pulling stress at the point of intersection therebetween.

The rings 32 may also be used to ligate orthodontic archwires to orthodontic brackets. The dimensions of the rings 32 are similar to the dimensions of the rings 22 as illustrated in FIG. 3 and described hereinabove in conjunction therewith.

The durometer or elasticity of the rings 32 may be varied by changing the composition thereof. The rings 32 may be manufactured in a variety of colors to indicate variations in the cross sectional thickness and the durometer thereof. Similarly, different colors are desirable to patients offering color combinations that add flair or changeable colors for personal choice for variety. The rings 22 are preferably manufactured from a silicone material selected from the group consisting of TUFEL® II 94706 and LIM® 6040.

Referring to FIG. 5, there is shown a fourth embodiment of the invention. In accordance with the fourth embodiment, a tube 40 is manufactured utilizing conventional plastic tube manufacturing techniques. As pointed out above in conjunction with the power bar 10, the chain 20, and the stick 30, a composition of the tube 40 may be varied in order to change the durometer or elasticity thereof. Tubes 40 comprising the present invention may be manufactured in a variety of colors to indicate differences in durometer or resistivity, differences in thickness, and color changes purely for variety during treatment.

In the practice of the invention the tube 40 is cut into a plurality of rings 42 utilizing any suitable cutting instrument. The rings 42 are similar in size and shape to the rings 22 of FIG. 3 and the rings 32 of FIG. 4. The rings 42 may be utilized similarly to the power bar 10 as illustrated in FIG. 2 and described hereinabove in conjunction therewith.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. For use in the practice of orthodontia, an elastomeric member formed from one or more silicone compounds and connectable between orthodontic appliances secured to the teeth of a patient to apply constant pressure therebetween.

2. (canceled)

3. The invention according to claim 1 wherein the elastomeric member has a constant thickness throughout its length.

4. The invention according to claim 1 wherein elastomeric member is a chain comprising a series of substantially identical rings with the shape of a connecting portion sloping from the ring to a section that is slightly larger in diameter to the cross section of the rings themselves.

5. (canceled)

6. (canceled)
